(19) United States
(12) Patent Application Publication
(10) Pub. No.: US 2014/0139056 A1
(43) Pub. Date: May 22, 2014

(54) COOLING FIXTURE AND MOTOR DEVICE USING SAME

(71) Applicant: HON HAI PRECISION INDUSTRY CO., LTD., New Taipei (TW)

(72) Inventor: MIN-TSANG TSENG, New Taipei (TW)

(73) Assignee: HON HAI PRECISION INDUSTRY CO., LTD., New Taipei (TW)

(21) Appl. No.: 13/729,062

(22) Filed: Dec. 28, 2012

(30) Foreign Application Priority Data
Nov. 19, 2012 (TW) 101143164

(51) Int. Cl. F28F 3/12; H02K 9/19

(52) U.S. Cl. CPC F28F 3/12; H02K 9/19
USPC 310/54; 165/168

(57) ABSTRACT

A motor device includes a main body and a cooling fixture carrying the main body. The cooling fixture includes a contacting surface projecting relative to the main body. The contacting surface is configured for contacting a mold. The cooling fixture defines a cooling water channel.

### BACKGROUND

1. Technical Field

The present disclosure relates to a motor device used in a molding device.

2. Description of Related Art

Melted material injected into a mold makes the mold have a high temperature. Conventionally, a motor device used in the mold directly contacts with the mold and heat is transferred to the motor device from the mold. The transferred heat may burn the motor device.

Therefore, it is desired to provide a cooling fixture and a motor device which can overcome the above mentioned problems.

### BRIEF DESCRIPTION OF THE DRAWINGS

FIG. 1 is a schematic, isometric view of a motor device according to an exemplary embodiment, the motor device including a cooling fixture.

FIG. 2 is an exploded view of the motor device of FIG. 1.

FIG. 3 is a schematic, isometric view of the cooling fixture of FIG. 1.

FIG. 4 is a perspective, cross-sectional view of the cooling fixture of FIG. 3.

FIG. 5 is a cross-sectional view taken along V-V line of the motor device of FIG. 1.

### DETAILED DESCRIPTION

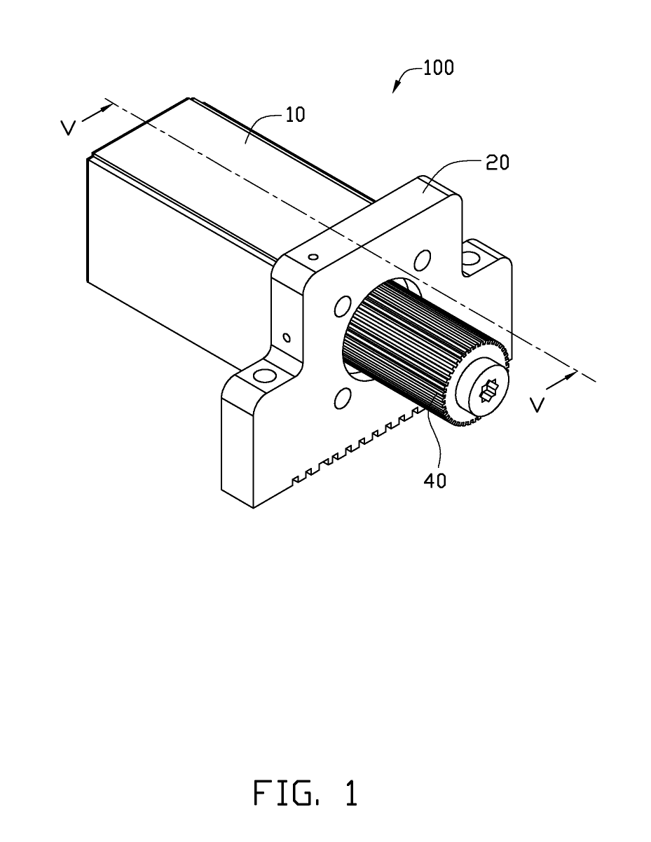

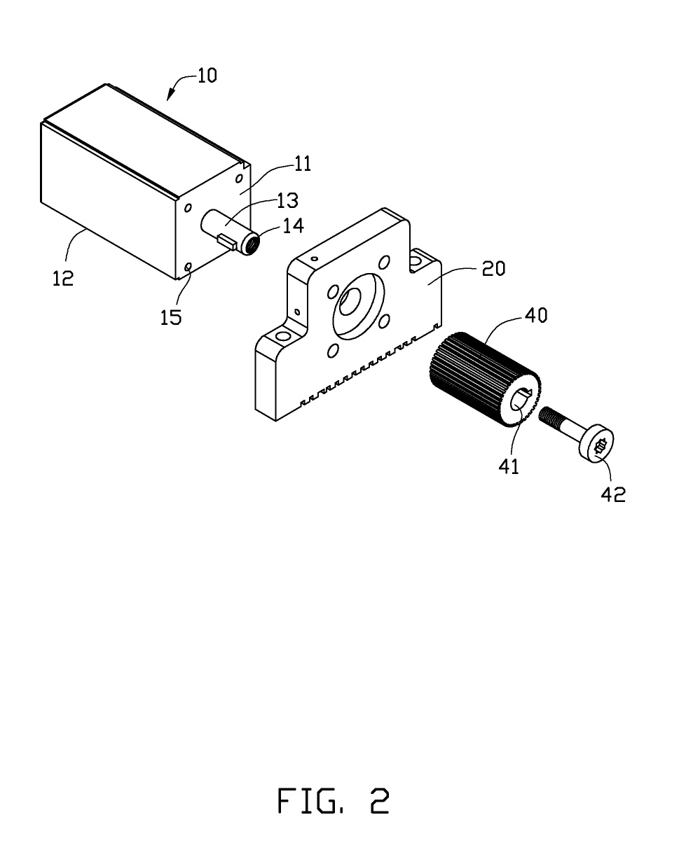

FIGS. 1 and 2 show a motor device 100. The motor device 100 is used to drive a gear 40 of a mold to rotate. The motor device 100 includes a main body 10 and a cooling fixture 20.

The main body 10 is substantially rectangular shaped, and includes an end surface 11 and a bottom surface 12 adjoining to the end surface 11. The main body 10 further includes a drive shaft 13 projecting from the end surface 11. In the embodiment, the drive shaft 13 is hollow. A screwed hole 14 is formed on the drive shaft 13. The end surface 11 defines a number of fixing holes 15 surrounding the drive shaft 13.

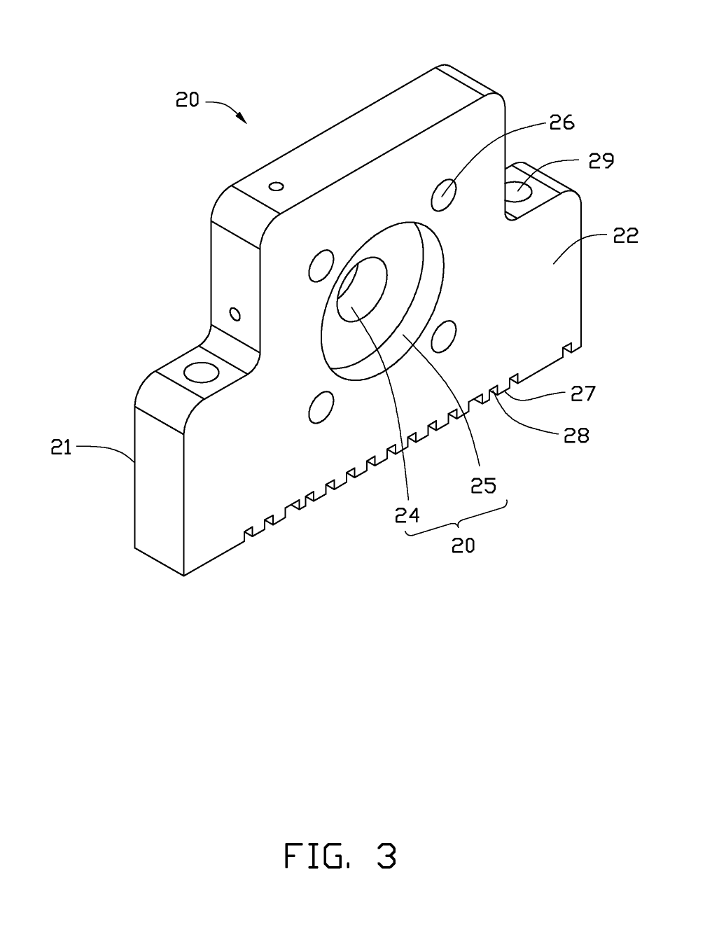

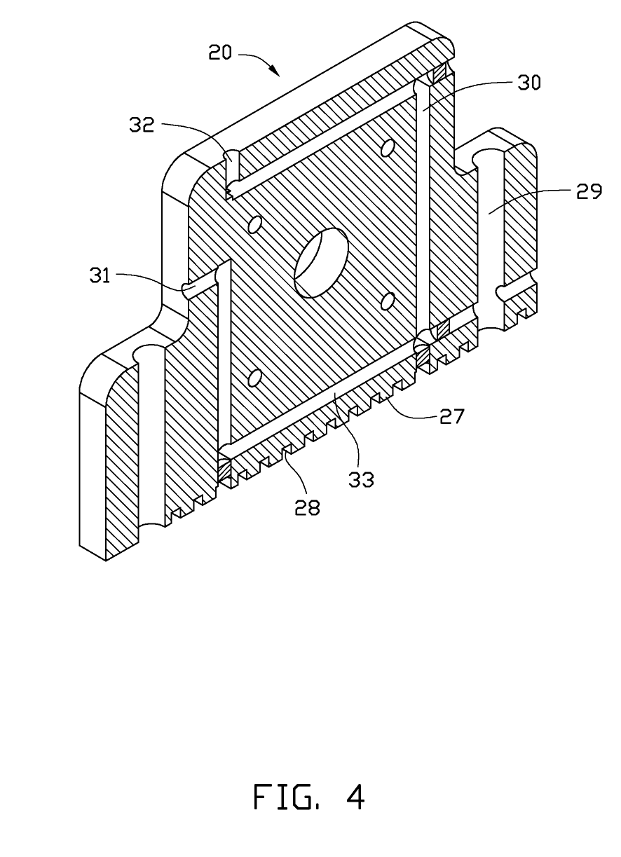

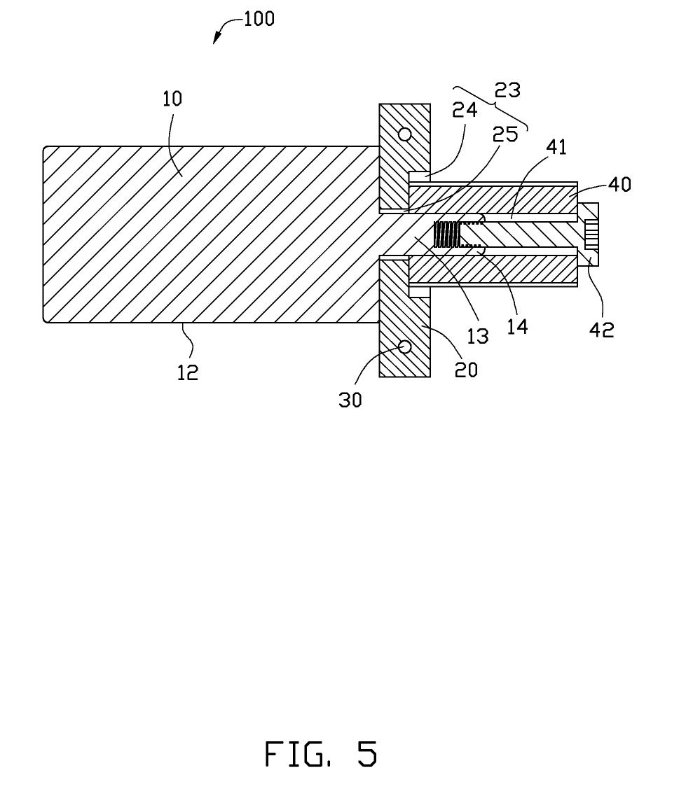

Referring to FIGS. 3, 4 and 5, the cooling fixture 20 is substantially T shaped, and includes two opposite side surfaces 21, 22. The cooling fixture 20 includes a stepped through hole 23 extending from the side surface 21 to the side surface 22. The stepped through hole 23 includes a smaller hole 24 adjacent to the side surface 21 and a bigger hole 25 adjacent to the side surface 22. A diameter of the smaller hole 24 is bigger than a diameter of the drive shaft 13 and is smaller than a diameter of the gear 40. A diameter of the bigger hole 25 is bigger than the diameter of the gear 40. The cooling fixture 20 further includes a number of fixing holes 26 extending from the side surface 21 to the side surface 22. The fixing holes 26 correspond to the fixing holes 15 respectively. Screws (not shown) extend through the fixing holes 26 and are inserted into the fixing holes 15, to connect the main body 10 with the cooling fixture 20. The end surface 11 contacts with the side surface 21. The drive shaft 13 extends through the stepped through hole 23. The gear 40 is hollow and defines a receiving hole 41. The drive shaft 13 is inserted into the receiving hole 41. A screw 42 is inserted into the receiving hole 41 and the screw hole 14 to fix the gear 40 on the drive shaft 13.

The cooling fixture 20 further includes a contacting surface 27 connected to the side surfaces 21, 22 respectively. The contacting surface 27 is projected relative to the main body 10 and contacts the mold (not shown). The contacting surface 27 defines a number of trenches 28. The trenches 28 reduce the contact area between the contacting surface 27 and the mold, and heat transferred from the mold to the cooling fixture 20 is reduced correspondingly. The cooling fixture 20 further defines a through hole 29 for receiving screws (not shown) to fix the cooling fixture 20 on the mold.

The cooling fixture 20 defines a cooling water channel 30. The cooling water channel 30 includes a water inlet 31 and a water outlet 32. The cooling water channel 30 surrounds the stepped through hole 23, and includes a sub channel 33 adjacent to and paralleled with the contacting surface 27.

When in use, cooling water flows into the cooling water channel 30 from the water inlet 31, and flows out from the water outlet 32. The cooling water takes away heat transferred from the mold and the gear 40. Thus, the heat will not be transferred to the main body 10 and burn the main body 10.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A motor device, comprising:
a main body; and
a cooling fixture carrying the main body, the cooling fixture comprising a contacting surface projecting relative to the main body, the contacting surface configured for contacting a mold, the cooling fixture defining a cooling water channel.

2. The motor device of claim 1, wherein the contacting surface defines a plurality of trenches.

3. The motor device of claim 1, wherein the cooling fixture comprises a side surface, the main body is fixed on the side surface, the cooling fixture defines a through hole through the side surface, and the main body comprises a drive shaft extending through the through hole.

4. The motor device of claim 3, wherein the through hole is a stepped hole and comprises a smaller hole adjacent to the side surface and a bigger hole far away from the side surface relative to the smaller hole.

5. The motor device of claim 3, wherein the cooling water channel surrounds the through hole.

6. A cooling fixture, comprising:
a contacting surface defining a plurality of trenches; and
a cooling water channel defined therein.

7. The cooling fixture of claim 6, further comprising a side surface, the cooling fixture defining a through hole through the side surface.

8. The cooling fixture of claim 7, wherein the through hole is a stepped hole and comprises a smaller hole adjacent to the side surface and a bigger hole far away from the side surface relative to the smaller hole.

9. The cooling fixture of claim 7, wherein the cooling water channel surrounds the through hole.
